(19) United States
(12) Patent Application Publication
(10) Pub. No.: US 2026/0298612 A1
(43) Pub. Date: Oct. 1, 2026

(54) METHOD FOR DRIVING LASER LIGHT SOURCE AND LASER INTERFEROMETER

(71) Applicant: SEIKO EPSON CORPORATION, TOKYO (JP)

(72) Inventors: Nobuhito HAYASHI, Chino-shi (JP); Kohei YAMADA, SHIOJIRI-SHI (JP)

(21) Appl. No.: 19/631,207

(22) Filed: Mar. 27, 2026

(30) Foreign Application Priority Data
Mar. 28, 2025 (JP) 2025-055271

(51) Int. Cl. G01B 9/02002; G01B 9/02001

(52) U.S. Cl. CPC G01B 9/02002; G01B 9/02012

(57) ABSTRACT

A method for driving a laser light source provided in a laser interferometer configured to measure displacement of a object, the laser interferometer including the laser light source configured to output pulse laser light, an optical frequency modulator configured to modulate an optical frequency of the pulse laser light to generate reference light, and a photodetector configured to receive object light generated when the object is irradiated with the pulse laser light and the reference light, and output a light reception signal, the method including setting a pulse width of the pulse laser light based on a first optical path length from the laser light source to the object.

The present application is based on, and claims priority from JP Application Serial Number 2025-055271, filed Mar. 28, 2025, the disclosure of which is hereby incorporated by reference herein in its entirety.

### BACKGROUND

### 1. Technical Field

The present disclosure relates to a method for driving a laser light source and a laser interferometer.

### 2. Related Art

JP-A-2007-285898 discloses a laser vibrometer as an apparatus that measures a vibration speed of an object. The laser vibrometer irradiates an object under measurement with laser light and measures the vibration speed based on scattered laser light subjected to a Doppler shift.

In the laser vibrometer described in JP-A-2007-285898, a semiconductor laser and a microchip solid-state laser exemplify a light source of the laser light. In general, the lasers described above each tend to have a shorter life as the period during which the laser outputs the laser light is longer (as energization period is longer). In addition, the life of each of the lasers tends to be shorter as the current that drives the laser is greater, and the temperature in the environment in which the laser is installed is higher.

JP-A-2007-285898 is an example of the related art.

The decrease in the life of the light source of the laser vibrometer causes a decrease in the usability of the laser vibrometer. It is conceivable to extend the life by reducing the intensity of the output laser light, in which case, however, the optical intensity of the laser light decreases, so that the accuracy of the measurement of the vibration speed of the object decreases.

It is therefore required to suppress the decrease in the measurement accuracy while extending the life of the laser light source of the laser interferometer.

### SUMMARY

A method for driving a laser light source according to an application example of the present disclosure is a method for driving a laser light source provided in a laser interferometer configured to measure displacement of an object,
the laser interferometer including
the laser light source configured to output pulse laser light,
an optical frequency modulator configured to modulate an optical frequency of the pulse laser light to generate reference light, and
a photodetector configured to receive object light generated when the object is irradiated with the pulse laser light and the reference light, and output a light reception signal,
the method including setting a pulse width of the pulse laser light based on a first optical path length from the laser light source to the object.

A laser interferometer according to another application example of the present disclosure is a laser interferometer configured to measure displacement of a object, the laser interferometer including:
a laser light source configured to output pulse laser light;
an optical frequency modulator configured to modulate an optical frequency of the pulse laser light to generate reference light;
a photodetector configured to receive object light generated when the object is irradiated with the pulse laser light and the reference light, and output a light reception signal;
a demodulator configured to demodulate the light reception signal to extract information derived from the object; and
a light source driver configured to set a pulse width of the pulse laser light based on a first optical path length from the laser light source to the object, and drive the laser light source.

### BRIEF DESCRIPTION OF THE DRAWINGS

FIG. 1 is a schematic configuration diagram showing a laser interferometer according to a first embodiment.

FIG. 2 is a perspective view showing an example of the configuration of an optical frequency modulator shown in FIG. 1.

FIG. 3 is a perspective view showing another example of the configuration of the optical frequency modulator shown in FIG. 1.

FIG. 4 is a graph showing an example of the output waveform of pulse laser light output from a laser light source subjected to pulse driving performed by a light source driver.

FIG. 5 is a timing chart showing changes in the intensity of object light at a photodetector, changes in the intensity of reference light at the photodetector, and sampling points where a demodulator samples a light reception signal.

FIG. 6 is a schematic configuration diagram showing a laser interferometer according to a second embodiment.

FIG. 7 is a conceptual view for illustrating the operation of an optical intensity modulator shown in FIG. 6.

FIG. 8 is a schematic configuration diagram showing a laser interferometer according to a third embodiment.

### DESCRIPTION OF EMBODIMENTS

A method for driving a laser light source and a laser interferometer according to an aspect of the present disclosure will be described below in detail based on embodiments shown in the accompanying drawings.

### 1. First Embodiment

A laser interferometer according to a first embodiment will first be described.

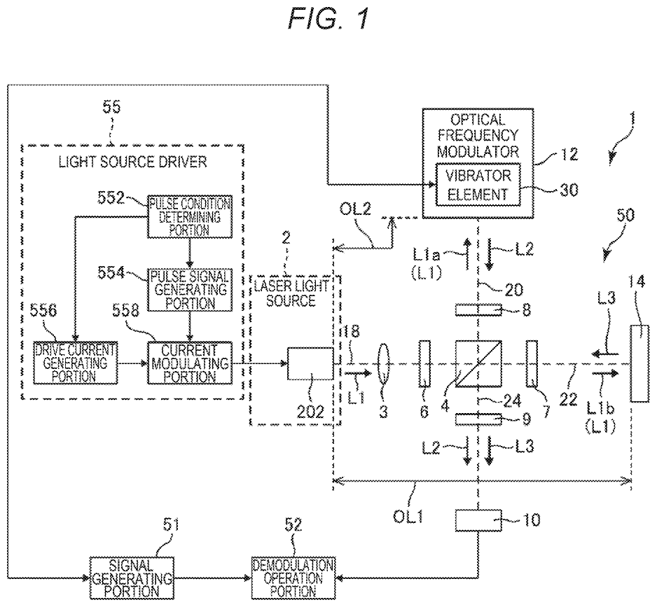

FIG. 1 is a schematic configuration diagram showing a laser interferometer 1 according to the first embodiment.

The laser interferometer 1 shown in FIG. 1 includes an interference optical system 50, a signal generating portion 51, a demodulator 52, and a light source driver 55. The laser interferometer 1 measures the displacement or speed of a object 14 based on optical heterodyne interferometry. The laser interferometer 1 is therefore used, for example, as a displacement meter or a speedometer.

The interference optical system 50 shown in FIG. 1 includes a laser light source 2, an optical frequency modulator 12, and a photodetector 10.

The laser light source 2 outputs pulse laser light L1.

The optical frequency modulator 12 modulates the optical frequency of the pulse laser light L1 to generate reference light L2.

The photodetector 10 receives object light L3 and the reference light L2 and outputs a light reception signal. The object light L3 is generated when the object 14 is irradiated with the pulse laser light L1, and contains a sample signal (such as phase information added to object light L3) added by the object 14. The reference light L2 contains a modulation signal (such as frequency information added to reference light L2) added by the optical frequency modulator 12.

The demodulator 52 demodulates the light reception signal to extract information (such as phase information) derived from the object 14.

The light source driver 55 sets the pulse width of the pulse laser light L1 based on a first optical path length OL1 from the laser light source 2 to the object 14, and drives the laser light source 2.

The configuration described above allows measurement of the displacement of the object 14 even when continuous oscillation laser light is not used but the pulse laser light L1 is used. The output per pulse can therefore be increased as necessary, so that the S/N ratio (signal-to-noise ratio) of the light reception signal can be increased while the period during which the laser light source 2 is driven is shortened. A decrease in the accuracy of the measurement of the object 14 can thus be suppressed while the life of the laser light source 2 is extended.

### 1.1. Interference Optical System

The interference optical system 50 shown in FIG. 1 is a Michelson interference optical system. The interference optical system 50 includes the laser light source 2, a collimation lens 3, a light divider 4, a half-wave plate 6, a quarter-wave plate 7, a quarter-wave plate 8, an analyzer 9, and the photodetector 10, as shown in FIG. 1.

The optical path that couples the light divider 4 to the laser light source 2 is referred to as an optical path 18. The optical path that couples the light divider 4 to the optical frequency modulator 12 is referred to as an optical path 20. The optical path that couples the light divider 4 to the object 14 is referred to as an optical path 22. The optical path that couples the light divider 4 to the photodetector 10 is referred to as an optical path 24. Note that the “light path” in the present specification refers to a path which is set between optical elements and along which light travels.

The collimation lens 3 and the half-wavelength plate 6 are arranged in this order from the side facing the laser light source 2 in the optical path 18. The quarter-wave plate 8 is disposed in the optical path 20. The quarter-wave plate 7 is disposed in the optical path 22. The analyzer 9 is disposed in the optical path 24.

The pulse laser light L1 output from the laser light source 2 travels along the optical path 18 and is divided by the light divider 4 into two types of light, first divided light L1a and second divided light L1b. The first divided light L1a travels along the optical path 20 and is incident on the optical frequency modulator 12. The second divided light L1b travels along the optical path 22 and is incident on the object 14. The reference light L2 generated by the optical frequency modulator 12 travels along the optical paths 20 and 24 and is incident on the photodetector 10. The object light L3 generated by the object 14 travels along the optical paths 22 and 24 and is incident on the photodetector 10.

In the laser interferometer 1 including the thus configured interference optical system 50, information derived from the object 14 can be acquired by optical heterodyne interferometry. Specifically, two types of light slightly different in optical frequency from each other (reference light L2 and object light L3) are caused to interfere with each other at a light receiving surface of the photodetector 10. Thereafter, the demodulator 52 extracts the sample signal from the intensity of the interference light, and calculates the displacement or the like of the object 14.

The portions that constitute the interference optical system 50 will be further described below.

### 1.1.1. Laser Light Source

The laser light source 2 includes a laser element 202. The laser element 202 outputs the pulse laser light L1, which is coherent and has an optical frequency f₀. Examples of the laser element 202 may include a gas laser such as a He-Ne laser, and a semiconductor laser element such as a distributed feedback laser diode (DFB-LD), a fiber-Bragg-grating-containing laser diode (FBG-LD), a vertical cavity surface emitting laser (VCSEL), and a Fabry-Perot laser diode (FP-LD).

It is particularly preferable that the laser element 202 is a semiconductor laser element. In this case, the laser light source 2 can in particular be reduced in size. Reduction in size of the laser interferometer 1 can therefore be achieved.

Furthermore, in the present embodiment, the pulse laser light L1 is output by direct modulation (internal modulation) of the laser light source 2.

Note that the laser element 202 may be a wavelength-swept laser element that outputs pulse laser light L1 having a wavelength that continuously changes, or a wavelength-fixed laser element that outputs pulse laser light L1 having a fixed wavelength. Out of the two candidates described above, using the latter wavelength-fixed laser element provides advantages such as simplification of the configuration of the laser light source 2, reduction in size thereof, and reduction in load applied thereto.

### 1.1.2. Collimation Lens

The collimation lens 3 is an optical element disposed between the laser light source 2 and the light divider 4, and is, for example, an aspherical lens. The collimation lens 3 parallelizes the pulse laser light L1 output from the laser light source 2 into collimated light. Note that when the pulse laser light L1 output from the laser light source 2 is sufficiently parallelized, the collimation lens 3 may be omitted.

The pulse laser light L1 parallelized into the collimated light passes through the half-wave plate 6, which converts the pulse laser light L1 into linearly-polarized light having an intensity ratio between P-polarized light to S-polarized light of, for example, 50:50, which then enters the light divider 4.

### 1.1.3. Light Divider

The light divider 4 is a polarizing beam splitter disposed between the laser light source 2 and the optical frequency modulator 12 and between the laser light source 2 and the object 14. The light divider 4 has the function of transmitting P-polarized light and reflecting S-polarized light. The light divider 4 having the function described above divides the pulse laser light L1 into the first divided light L1a and the second divided light L1b.

The first divided light L1a, which is S-polarized light, is converted by the quarter-wave plate 8 into circularly polarized light, which is incident on the optical frequency modulator 12. The first divided light L1a (divided pulse laser light L1) incident on the optical frequency modulator 12 is subjected to a frequency shift f_{M} [Hz] and reflected as the reference light L2 containing the modulation signal. The optical frequency of the reference light L2 is therefore f₀+f_{M}. The reference light L2 is converted into P-polarized light when passing through the quarter-wave plate 8 again. The P-polarized reference light L2 passes through the light divider 4 and the analyzer 9 and is incident on the photodetector 10.

The second divided light L1b, which is P-polarized light, is converted into circularly polarized light by the quarter-wave plate 7 and is incident on the object 14, which is displaced. The second divided light L1b (divided pulse laser light L1) incident on the object 14 is subjected to a Doppler shift f_{D} [Hz], and is reflected as the object light L3 containing the sample signal. The optical frequency of the object light L3 is therefore f₀+f_{D}. The object light L3 is converted into S-polarized light when passing through the quarter-wave plate 7 again. The object light L3 is reflected off the light divider 4, passes through the analyzer 9, and is then incident on the photodetector 10. The reference light L2 and the object light L3 are incident as interference light on the photodetector 10.

### 1.1.4. Analyzer

Since S-polarized light and P-polarized light perpendicular to each other are independent of each other, beating resulting from interference may not appear when the two types of polarized light are simply superimposed on each other. In view of the fact described above, a light wave as a result of superposition of S-polarized light and P-polarized light is caused to pass through the analyzer 9 tilted by 45° with respect to both the S-polarized light and the P-polarized light. Using the analyzer 9 causes the reference light L2 and the object light L3 to favorably interfere with each other, so that interference light having a beat frequency |f_{M}−f_{D}| is generated.

### 1.1.5. Photodetector

When the interference light is incident on the photodetector 10, the photodetector 10 outputs a photocurrent (light reception signal) according to the intensity of the interference light. A method described later is used to demodulate the light reception signal to extract the sample signal. The photodetector 10 is, for example, a photodiode. Note that the light received by the photodetector 10 may be laser light on which the modulation signal and the sample signal are superimposed as a result of traveling via the optical frequency modulator 12 and the object 14, and is not limited to the interference light generated along the paths described above. The phrase “demodulating the light reception signal to extract the sample signal” in the present specification refers to extracting the sample signal by performing various types of operation on the light reception signal. Note in the following description that not only the photocurrent described above but also a voltage signal into which the photocurrent is converted is collectively referred to as the “light reception signal”.

### 1.2. Optical Modulator

The optical frequency modulator 12 shown in FIG. 1 is a vibrator-type optical frequency modulator including a vibrator element 30. The optical frequency modulator 12 modulates the optical frequency of the first divided light L1a by using the vibration of the vibrator element 30. According to the configuration described above, reduction in size, weight, and power consumption of the optical frequency modulator 12 can be achieved. The vibration of the vibrator element 30 serves as source vibration that causes the signal generating portion 51 to generate a reference signal. Therefore, the modulation signal added by the vibrator element 30 to the reference light L2 and the reference signal output from the signal generating portion 51 with the vibrator element 30 serving as the source vibration are both derived from vibration energy of the vibrator element 30. Therefore, even when disturbance such as impact and noise acts on the optical frequency modulator 12 so that the vibration of the vibrator element 30 changes, both the modulation signal and the reference signal change in the same manner. The influences of the disturbances on both the modulation signal and the reference signal can therefore be canceled out or reduced in the course of the operation in the demodulator 52. As a result, a decrease in the S/N ratio (signal-to-noise ratio) of the sample signal extracted by the demodulation performed by the demodulator 52 can be suppressed.

The vibrator element 30 is, for example, a vibrator using a mechanical resonance phenomenon, such as a quartz crystal vibrator, a ceramic vibrator, or a silicon vibrator. The mechanical resonance of the vibrators described above has a high Q value and excels in the stability of the frequency of the vibration.

Examples of the quartz crystal vibrator may include a quartz crystal AT vibrator, an SC-cut quartz crystal vibrator, a tuning-fork-type quartz crystal vibrator, and a quartz crystal surface acoustic wave element. The oscillation frequency of the quartz crystal vibrator is approximately, for example, from 1 kHz to several hundreds of MHz.

The silicon vibrator is a vibrator including a single crystal silicon element manufactured from a single crystal silicon substrate by using a MEMS technology, and a piezoelectric film. MEMS is an abbreviation for microelectromechanical systems. The single crystal silicon element may, for example, have the shape of a cantilever, such as a two-leg or three-leg, tuning-fork-type beam, or the shape of a double-supported beam. The oscillation frequency of the silicon vibrator is approximately, for example, from 1 kHz to several hundreds of MHz.

The ceramic vibrator is a vibrator including a piezoelectric ceramic element manufactured by sintering and hardening a piezoelectric ceramic material, and electrodes. Examples of the piezoelectric ceramic material may include lead zirconate titanate (PZT), barium titanate (BTO), and potassium sodium niobate (KNN). The oscillation frequency of the ceramic vibrator is approximately, for example, from several hundreds of kHz to several tens of MHz.

Out of the vibrators described above, a quartz crystal vibrator is preferably used as the vibrator element 30. The quartz crystal vibrator has particularly high frequency stability because the quartz crystal itself is a piezoelectric material.

The oscillation frequency of the vibrator element 30 is not particularly limited to a specific value, and is preferably higher than or equal to 1 MHz but lower than or equal to 100 MHz. In a frequency band that falls within the range described above, many vibrators having a high Q value of mechanical resonance are available. Setting the oscillation frequency to a value that falls within the range described above can therefore stabilize a reference frequency of the reference signal output from the signal generating portion 51.

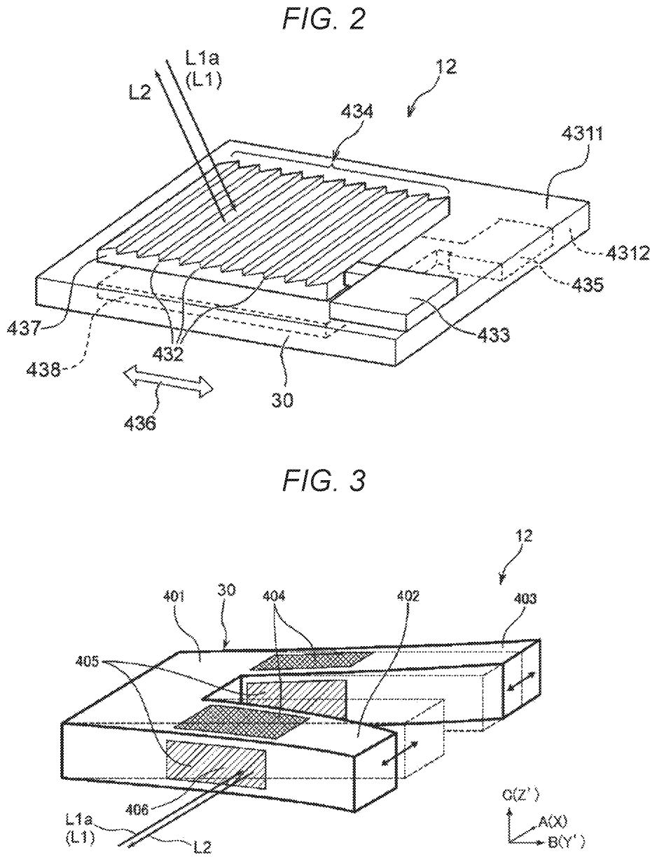

FIG. 2 is a perspective view showing an example of the configuration of the optical frequency modulator 12 shown in FIG. 1.

The optical frequency modulator 12 shown in FIG. 2 may, for example, be an optical modulator disclosed in JP-A-2022-038156. Specifically, the optical frequency modulator 12 shown in FIG. 2 includes the vibrator element 30 and a diffraction grating 434, which is provided at the vibrator element 30 and diffracts the first divided light L1a (divided laser light).

The vibrator element 30 shown in FIG. 2 is a quartz crystal AT vibrator that performs thickness-shear vibration along a vibration direction 436 in a MHz-band high-frequency region. The vibrator element 30 is provided with the diffraction grating 434. The diffraction grating 434 has multiple linear grooves 432 extending in a direction that intersects with the vibration direction 436. When the thus configured diffraction grating 434 is irradiated with the first divided light L1a, the frequency of the first divided light L1a is so modulated that the reference light L2 can be generated even when the vibrator element 30 performs the thickness-shear vibration.

The vibrator element 30 has a front surface 4311 and a rear surface 4312, which are surfaces on opposite sides of the vibrator element 30. The diffraction grating 434 is disposed at the front surface 4311. A first electrode 437 used to apply a voltage to the vibrator element 30 and a pad 433 electrically coupled to the first electrode 437 are disposed at the front surface 4311. A second electrode 438 used to apply the voltage to the vibrator element 30 and a pad 435 electrically coupled to the second electrode 438 are disposed at the rear surface 4312. The first electrode 437 and the second electrode 438 are disposed to coincide with each other with the vibrator element 30 interposed therebetween in the plan view of the front surface 4311. When the voltage is applied to the gap between the first electrode 437 and the second electrode 438, thickness-shear vibration is induced in the portion where the first electrode 437 and the second electrode 438 coincide with each other in the plan view.

The diffraction grating 434 shown in FIG. 2 is disposed on the first electrode 437. That is, in FIG. 2, the diffraction grating 434 is configured with the multiple grooves 432 formed at the surface of the first electrode 437, and when the diffraction grating 434 is irradiated with the first divided light L1a, the reference light L2 is output as diffracted light.

The diffraction grating 434 shown in FIG. 2 is a blazed diffraction grating by way of example. The blazed diffraction grating refers to a diffraction grating having a stepped cross-sectional shape. Note that the diffraction grating 434 does not necessarily have the shape described above.

FIG. 3 is a perspective view showing another example of the configuration of the optical frequency modulator 12 shown in FIG. 1. Note in FIG. 3 that an A-axis, a B-axis, and a C-axis are set as three axes orthogonal to each other, and are indicated by arrows. The tip side of each of the arrows is called a “positive” side, and the base end side of the arrow is called a “negative” side.

The vibrator element 30 shown in FIG. 3 is a tuning-fork-type quartz crystal vibrator. The vibrator element 30 shown in FIG. 3 includes a vibrating substrate including a base 401, a first vibrating arm 402, and a second vibrating arm 403. The thus configured tuning-fork-type quartz crystal vibrator is readily available, and is also stable in terms of oscillation because the technology for manufacturing thereof has been established. A tuning-fork-type quartz crystal vibrator is therefore suitable as the vibrator element 30. The optical frequency modulator 12 shown in FIG. 3 includes the vibrator element 30, and electrodes 404 and 405 and a light reflector 406 provided at the vibrator element 30.

The base 401 is a portion extending along the A-axis. The first vibrating arm 402 is a portion extending toward the positive side of the B-axis from an end portion of the base 401 that is shifted toward the negative side of the A-axis. The second vibrating arm 403 is a portion extending toward the positive side of the B-axis from an end portion of the base 401 that is shifted toward the positive side of the A-axis.

The electrodes 404 are electrically conductive films provided at side surfaces of the first vibrating arm 402 and the second vibrating arm 403 that are side surfaces parallel to an A-B plane. Although not shown in FIG. 3, the electrodes 404 are disposed at side surfaces facing each other, and drive the first vibrating arm 402 and the second vibrating arm 403 when voltages having polarities different from each other are applied to the electrodes 404.

The electrodes 405 are electrically conductive films provided at side surfaces of the first vibrating arm 402 and the second vibrating arm 403 that are side surfaces intersecting with the A-B plane. Although not shown in FIG. 3, the electrodes 405 are also provided at side surfaces facing each other, and drive the first vibrating arm 402 and the second vibrating arm 403 when voltages having polarities different from each other are applied to the electrodes 405.

The light reflector 406 is set at a side surface of the first vibrating arm 402 or the second vibrating arm 403 that is a side surface intersecting, for example, with the A-B plane, and has the function of reflecting the first divided light L1a. The light reflector 406 having the function described above has a vibration component having a large amplitude in the direction in which the first divided light L1a is incident, and therefore efficiently modulate the frequency of the first divided light L1a, so that the reference light L2 can be generated.

As the tuning-fork-type quartz crystal vibrator, a quartz crystal element cut out from a quartz crystal substrate is used. The quartz crystal substrate used to manufacture the tuning-fork-type quartz crystal vibrator may, for example, be a quartz crystal Z-cut planar plate. An X-axis parallel to the A-axis, a Y′-axis parallel to the B-axis, and a Z′-axis parallel to the C-axis are set in FIG. 3. The quartz crystal Z-cut planar plate is, for example, a substrate cut out from a quartz-crystal single crystal in a way that the X-axis is the electrical axis, the Y′-axis is the mechanical axis, and the Z′-axis is the optical axis. Specifically, in an orthogonal coordinate system having the X-axis, the Y′-axis, and the Z′-axis, a substrate having a principal surface that is an X-Y′ plane containing the X-axis and Y′-axis and tilted around the X-axis counterclockwise by an angle ranging approximately 1° to 5° is cut out from a quartz-crystal single crystal, and is preferably used as the quartz crystal substrate. The thus produced quartz crystal substrate is then etched into the quartz crystal element used in the vibrator element 30 shown in FIG. 3.

Note that the optical frequency modulator 12 is not limited to the vibrator-type modulator described above, and may, for example, be an acousto-optical modulator (AOM), or an electro-optic modulator (EOM).

### 1.3. Signal Generating Portion

The signal generating portion 51 shown in FIG. 1 generates the reference signal by using the vibrator element 30 as the source vibration.

Examples of the signal generating portion 51 may include an oscillation circuit using an inverter and a Colpitts oscillation circuit. The oscillation circuits described above operate based on fundamental mode oscillation of the vibrator element 30. The signal generating portion 51, which uses the vibrator element 30 having a high Q value of mechanical resonance, can generate a reference signal having high frequency stability.

Note that the optical frequency modulator 12 and the signal generating portion 51 may be housed in a single package. In this case, the physical distance between the optical frequency modulator 12 and the signal generating portion 51 is short, so that the influence of noise or the like on the reference signal is suppressed.

The signal generating portion 51 may instead include a signal generating device such as a function generator or a signal generator in place of any of the oscillation circuits described above.

### 1.4. Demodulator

The demodulator 52 shown in FIG. 1 performs preprocessing on the light reception signal based on the reference signal output from the signal generating portion 51. In the preprocessing, the light reception signal is split into two signals. Thereafter, one of the two signals is multiplied by the reference signal, and the two signals are then summed into a preprocessed signal. The demodulator 52 performs the demodulation based on the preprocessed signal and the reference signal. In the demodulation, the sample signal derived from the object 14 is extracted, and the displacement or speed of the object 14 is calculated from the sample signal.

As the demodulator 52 can, for example, be the preprocessor and the demodulator disclosed in JP-A-2022-038156.

### 1.5. Light Source Driver

The light source driver 55 shown in FIG. 1 includes a pulse condition determining portion 552, a pulse signal generating portion 554, a drive current generating portion 556, and a current modulating portion 558.

The pulse condition determining portion 552 has the function of determining the pulse width and the pulse repetition frequency of the pulse laser light L1 output by the laser light source 2. Specifically, the pulse width of the pulse laser light L1 is set based on the first optical path length OL1 from the laser light source 2 to the object 14. The optical path difference between the first optical path length OL1 and a second optical path length OL2, the latter of which is the length from the laser light source 2 to the optical frequency modulator 12, affects the delay period of the pulses of the object light L3 with respect to the pulses of the reference light L2. The pulse condition determining portion 552 can set the pulse width in an optimized manner in a way that the period for which the pulses of the object light L3 are active and the period for which the pulses of the reference light L2 are active overlap with each other. As a result, the photodetector 10 can receive appropriate interference light.

The pulse condition determining portion 552 has the function of determining a drive current (operating current) that drives the laser light source 2. A drive current suitable for the pulse width can thus be set.

The pulse signal generating portion 554 generates a pulse signal indicating the pulse width and the repetition frequency determined by the pulse condition determining portion 552.

The drive current generating portion 556 generates the drive current determined by the pulse condition determining portion 552.

The current modulating portion 558 changes the drive current generated by the drive current generating portion 556 to pulse drive current based on the pulse signal generated by the pulse signal generating portion 554. The pulse drive current is then output toward the laser light source 2. The laser light source 2 thus outputs the pulse laser light L1.

The thus configured light source driver 55 allows the photodetector 10 to receive appropriate interference light while performing pulse driving of the laser light source 2 to shorten the driving period. Furthermore, the output per pulse can be increased as necessary. A decrease in the accuracy of the measurement of the object 14 can thus be suppressed while the life of the laser light source 2 is extended.

### 1.6. Hardware Configuration

The functions of the demodulator 52 and the pulse condition determining portion 552 are each realized, for example, by hardware including a processor, a memory, an external interface, and other elements, which can communicate with each other via an external bus. The functions are specifically realized by the processor reading and executing a program stored in the memory.

Examples of the processor may include a central processing unit (CPU) and a digital signal processor (DSP). Note that the configuration in which any of the processors described above executes software may be replaced with a configuration in which a field-programmable gate array (FPGA), an application-specific integrated circuit (ASIC), or the like realizes the functions described above.

Examples of the memory may include a hard disk drive (HDD), a solid-state drive (SSD), an electrically erasable programmable read-only memory (EEPROM), a read-only memory (ROM), and a random access memory (RAM).

Examples of the external interface may include a digital input/output port such as a universal serial bus (USB), an Ethernet (registered trademark) port, a wireless LAN (local area network), and Bluetooth (registered trademark).

Note that the external interface and an input portion only need to be provided as required, and may be omitted.

### 2. Method for Driving Laser Light Source

A method for driving a laser light source according to the embodiment will next be described. In the following description, a method for driving the laser light source 2 provided in the laser interferometer 1 will be described by way of example.

In the laser interferometer 1 described above, the light source driver 55 sets the pulse width of the pulse laser light L1 based on the first optical path length OL1 from the laser light source 2 to the object 14.

The configuration described above can suppress a decrease in the S/N ratio (signal-to-noise ratio) of the light reception signal while extending the life of the laser light source 2 of the laser interferometer 1. The advantage described above is realized by the following operation of the light source driver 55.

### 2.1. Shortening Energization Period

The light source driver 55 performs pulse driving of the laser light source 2. Since the pulse driving can shorten the period (energization period) for which the drive current flows through the laser light source 2, the life of the laser light source 2 can be extended. In particular, when the laser light source 2 is used in a high-temperature environment, the life of the laser light source 2 shortens due to the high temperature. Performing pulse driving can reduce restrictions on the environment in which the laser light source 2 is used.

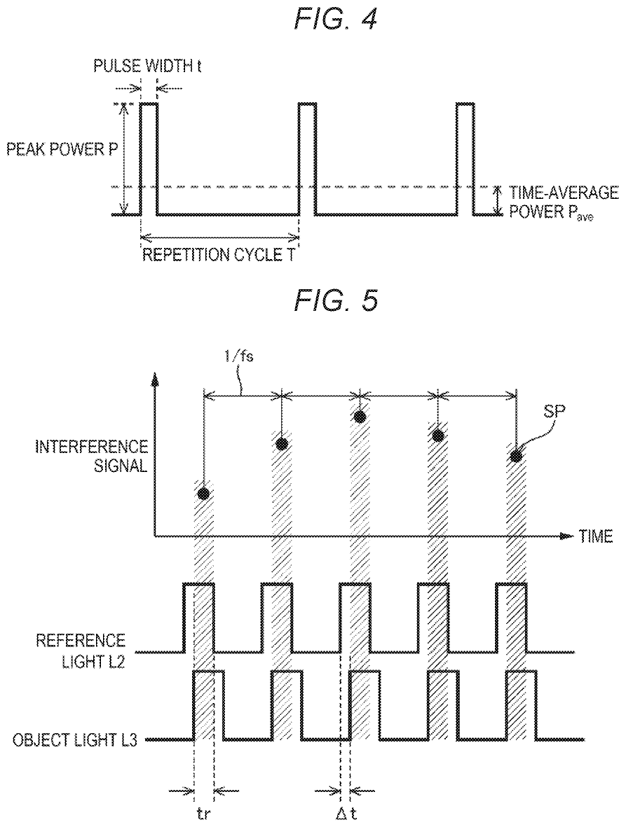

FIG. 4 is a graph showing an example of the output waveform of the pulse laser light L1 output from the laser light source 2 subjected to the pulse driving performed by the light source driver 55.

In the changes in the output shown in FIG. 4, an output period that lasts for a pulse width t during which a peak power P is provided and a non-output period are repeated in a repetition cycle T. The changes in the output allow the energization period of the laser light source 2 to be shortened by a factor of t/T. The life of the laser light source 2 can thus be extended by the factor of T/t as compared with a case where the laser light source 2 is continuously driven.

### 2.2. Safety Standard Compliance and Peak Power Enhancement

The changes in the output shown in FIG. 4 can be used to suppress a time-average power Pₐᵥₑ to t/T times the peak power P. The time-average power Pₐᵥₑ is thus likely to conform to laser instrument safety standards. That is, even when the peak power P is high, the pulse driving causes the laser light source 2 to be likely to conform to the safety standards. Employing the pulse driving therefore allows use of the laser light source 2 having peak power P higher than that in the continuous driving.

As an example, to satisfy laser class 2 specified in JIS C 6802:2018 (safety standards of laser products), it is necessary that the peak power P in a wavelength range between 400 nm and 700 nm does not exceed the accessible emission limit (AEL) of 1 mW. In the pulse driving, however, the time-average power Pₐᵥₑ within a time standard can be employed, so that the peak power P lasting for the pulse width t can be made greater than 1 mW accordingly. For example, when the pulse repetition cycle T is 1 μs and the pulse width t is 40 ns, the time-average power Pₐᵥₑ is 1/25 times the peak power P, so that the peak power P can be increased to 25 times the peak power P (25 mW) accordingly. The output per pulse of the pulse laser light L1 can therefore be increased with the class of the safety standard class maintained, so that the S/N ratio of the light reception signal can be increased. For example, a simulation of the light reception signal generated when the peak power P is increased by the factor of 25 has shown that the S/N ratio of the light reception signal can be improved by 28 dB.

In view of the findings described above, the pulse condition determining portion 552 preferably has the function of setting the pulse width t, the pulse repetition frequency, and the peak power P in a way that the time-average power Pₐᵥₑ satisfies a predetermined laser class. Specifically, the pulse condition determining portion 552 preferably has the function of adjusting the output (peak power P) of the pulse laser light L1 in accordance with the pulse width t and the pulse repetition frequency. The S/N ratio of the light reception signal can therefore be properly increased while the laser light source 2 conforms to the safety standards.

### 2.3. Optical Path Difference and Pulse Delay Period

The interference optical system 50 typically has an optical path difference ΔL between the first optical path length OL1 from the laser light source 2 to the object 14 and the second optical path length OL2 from the laser light source 2 to the optical frequency modulator 12. The optical path difference ΔL produces a time difference between the time when the pulses of the object light L3 reach the photodetector 10 and the time when the pulses of the reference light L2 reach the photodetector 10. Since the first optical path length OL1 is usually longer than the second optical path length OL2, the pulses of the object light L3 are delayed with respect to the pulses of the reference light L2. Let Δt be the delay period in the case described above. The delay period Δt is expressed by Δt=2ΔL/c. The constant c represents the speed of light. For example, when the optical path difference ΔL is 1 m, the delay period Δt is 6.7 ns. When the optical path difference ΔL is 5 m, the delay period Δt is 33.4 ns.

When such a delay period Δt occurs, the pulses of the object light L3 and the pulses of the reference light L2 do not temporally overlap with each other depending on the pulse width t, and the photodetector 10 cannot receive interference light. It is therefore preferable to set the pulse width t based on the time difference (delay period Δt) between the time when the pulses of the object light L3 reach the photodetector 10 and the time when the pulses of the reference light L2 reach the photodetector 10. Specifically, the pulse width t is preferably longer than the delay period Δt. The pulses of the object light L3 and the pulses of the reference light L2 can thus appropriately interfere with each other, so that the photodetector 10 can output a light reception signal containing an effective interference signal. Based on the light reception signal containing the interference signal, the demodulator 52 can perform effective demodulation.

In the photodetector 10, there is a time lag from the timing of reception of the interference light to the output of the light reception signal. The time lag is referred to as a response time Δt_{PD} of the photodetector 10. It is preferable to incorporate the response time Δt_{PD} into the pulse width t. In consideration of the time lag, it is more preferable in the light source driver 55 that the pulse width t is set to a value that satisfies the following expression:

Δt+Δt_{PD}<t

When the pulse width t satisfies the expression described above, the photodetector 10 can output the light reception signal containing an effective interference signal even when the pulse laser light L1 is used and there is a time lag between the timing when the photodetector 10 receives the interference light and the timing when the photodetector 10 outputs the light reception signal.

It is preferable in the light source driver 55 that the pulse width t is set to a value that satisfies the following expression:

0.1 [ns]≤T≤100 [ns]

When the pulse width t satisfies the expression described above, the photodetector 10 can receive appropriate interference light under many measurement conditions under which the laser interferometer 1 is used.

Note that the delay period Δt is derived from the optical path difference ΔL between the first optical path length OL1 and the second optical path length OL2, and that the second optical path length OL2 is fixed and is sufficiently shorter than the first optical path length OL1. The pulse width t may therefore be set based only on the first optical path length OL1 in the present embodiment. Specifically, when the physical distance between the laser interferometer 1 and the object 14 can be roughly grasped, the first optical path length OL1 may be roughly estimated from the physical distance, and the pulse width t may be determined based on the known second optical path length OL2.

When it is necessary to set the pulse width t more strictly, for example, when it is desired to set a shortest possible pulse width t without providing a large margin, the pulse width t may be set in consideration of the optical path difference ΔL between the first optical path length OL1 and the second optical path length OL2.

Note that the first optical path length OL1 may be stored in advance in the light source driver 55 or may be acquired via a sensor that is not shown. The sensor may, for example, be a distance measuring sensor that measures the physical distance between the laser interferometer 1 and the object 14. The pulse condition determining portion 552 acquires the first optical path length OL1 based on the physical distance acquired by the distance measuring sensor.

### 2.4. Sampling Performed by Demodulator

FIG. 5 is a timing chart showing changes in the intensity of the object light L3 at the photodetector 10, changes in the intensity of the reference light L2 at the photodetector 10, and sampling points SP, where the demodulator 52 samples the light reception signal.

The pulses of the object light L3 reach the photodetector 10 later than the pulses of the reference light L2, as shown in FIG. 5. Interference therefore occurs within a period (overlap period tr) in which the two pulses overlap with each other, so that the light reception signal containing an effective interference signal is output from the photodetector 10. The demodulator 52 therefore sets the sampling points SP in the overlap periods tr. The demodulator 52 can thus perform the demodulation based on the effective interference signal.

Let fs be the sampling frequency in the demodulator 52, and the sampling cycle is expressed by 1/fs. The sampling cycle 1/fs is preferably equal to the repetition cycle T of the pulses of the pulse laser light L1. That is, it is preferable that the sampling frequency fs in the demodulator 52 and the repetition frequency of the pulses of the pulse laser light L1 in the light source driver 55 are equal to each other. The sampling period 1/fs can thus coincide with the cycle in which the overlap periods tr described above appear. As a result, an effective interference signal can be reliably sampled at each of the sampling points SP.

Note that the sampling points SP may be synchronized with the overlap periods tr, for example, by using the rising edges of the pulses of the object light L3 as a trigger. Since the pulses of the object light L3 usually arrive later than the pulses of the reference light L2, the sampling points SP can fall within the overlap periods tr by setting the sampling points SP in accordance with the rising edges of the pulses of the object light L3. Note that the light reception signal reflects the sum of the optical intensity of the object light L3 and the optical intensity of the reference light L2. The demodulator 52 can therefore capture the rising edges of the pulses of the object light L3 based on changes in the intensity of the light reception signal.

The time difference between the rising edges of each of the pulses of the object light L3 and the rising edges of the pulses of the reference light L2 can be measured from the changes in the intensity of the light reception signal. The time difference corresponds to the delay period Δt described above. In this case, the pulse condition determining portion 552 of the light source driver 55 may have the function of calculating the optical path difference ΔL based on the time difference (delay period Δt). The first optical path length OL1 can thus be readily acquired, so that the pulse width t can be readily set under various measurement environments.

### 2. Second Embodiment

A laser interferometer according to a second embodiment will next be described.

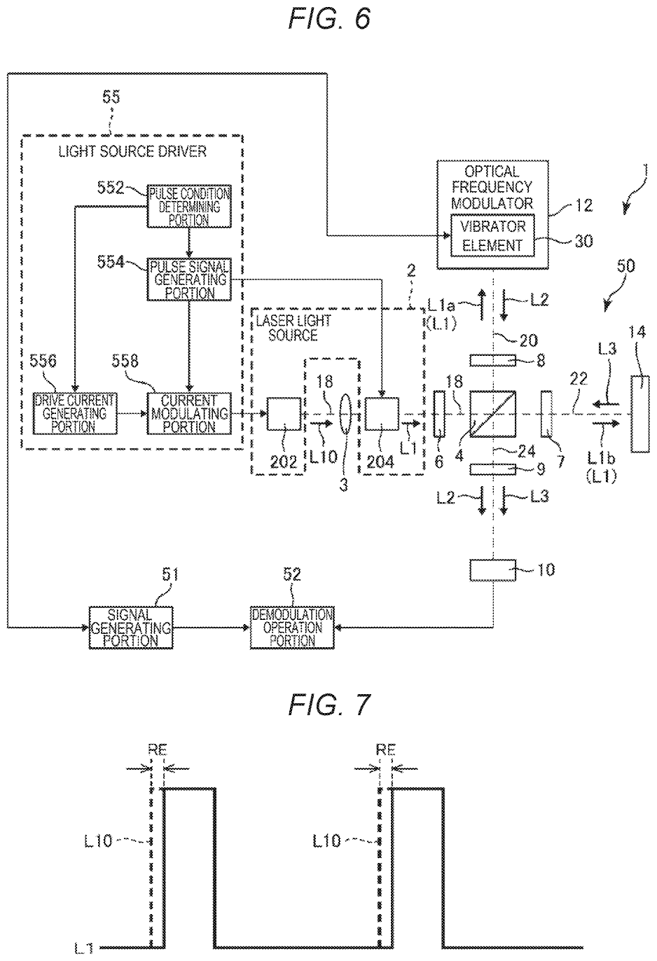

FIG. 6 is a schematic configuration diagram showing a laser interferometer 1 according to the second embodiment.

The second embodiment will be described below. In the following description, points different from those in the first embodiment will be primarily described, and the same items will not be described.

The laser interferometer 1 shown in FIG. 6 is the same as the laser interferometer 1 shown in FIG. 1 except that the laser light source 2 outputs the pulse laser light L1 with the aid of external modulation.

The laser light source 2 shown in FIG. 6 includes the laser element 202 and an optical intensity modulator 204.

The laser element 202 is operated by the pulse drive current generated by the current modulating portion 558 and outputs pulse laser light L10.

The optical intensity modulator 204 is disposed between the collimation lens 3 and the half-wave plate 6. The optical intensity modulator 204 performs light intensity modulation so as to remove some of the pulses of the pulse laser light L10 based on the pulse signal generated by the pulse signal generating portion 554.

FIG. 7 is a conceptual view for illustrating the operation of the optical intensity modulator 204 shown in FIG. 6. FIG. 7 shows an example of the output waveforms of the pulse laser light L10 output from the laser element 202 and the pulse laser light L1 as a result of the light intensity modulation performed by the optical intensity modulator 204 on the pulse laser light L10.

The optical intensity modulator 204 performs the optical intensity modulation so as to remove, for example, a rising portion RE of each of the pulses of the pulse laser light L10. The rising portion RE of each of the pulses contains wavelength fluctuation in some cases. Performing the optical intensity modulation so as to remove the rising portion RE allows removal of or reduction in the wavelength fluctuation. Pulse laser light L1 with less wavelength fluctuation can thus be generated. As a result, the S/N ratio of the light reception signal is further increased. The optical intensity modulator 204 may have, for example, the function of removing the rising portion RE of each of the pulses of the pulse laser light L10 or the function of transmitting the portion other than the rising portion RE of each of the pulses of the pulse laser light L10 in synchronization with the pulse signal output from the pulse signal generating portion 554.

The pulse signal generating portion 554 shown in FIG. 6 generates the pulse signal to be output to the current modulating portion 558 and a pulse signal to be output to the optical intensity modulator 204. The timing of the pulse signal output to the optical intensity modulator 204 is adjusted as appropriate with respect to the pulse signal output to the current modulating portion 558 in accordance with the function of the optical intensity modulator 204.

The thus configured second embodiment can also provide the same advantages as those provided by the first embodiment described above.

### 3. Third Embodiment

A laser interferometer according to a third embodiment will next be described.

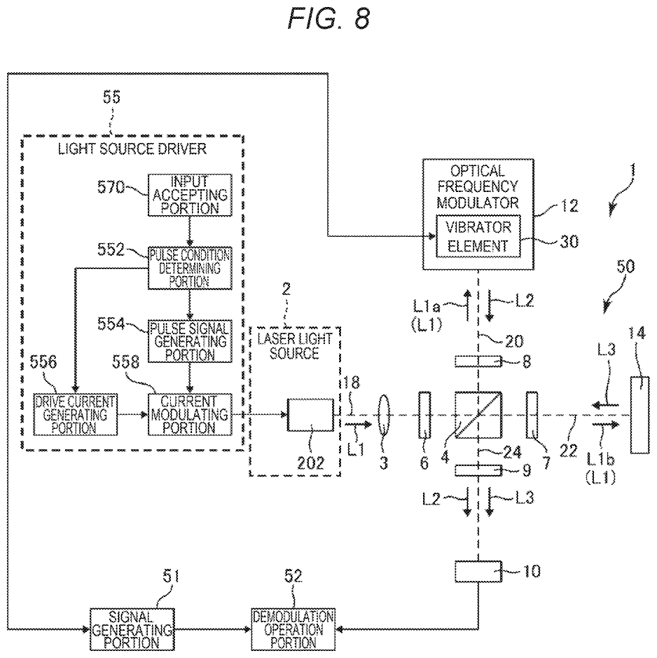

FIG. 8 is a schematic configuration diagram showing a laser interferometer 1 according to the third embodiment.

The third embodiment will be described below. In the following description, points different from those in the first embodiment will be primarily described, and the same items will not be described.

The light source driver 55 shown in FIG. 8 is the same as that of the laser interferometer 1 shown in FIG. 1 except that the light source driver 55 further includes an input accepting portion 570.

The input accepting portion 570 accepts an input operation performed by the user of the laser interferometer 1. The input operation is, for example, the operation of inputting the first optical path length OL1. Upon accepting the input of the first optical path length OL1, the input accepting portion 570 transmits the acquired first optical path length OL1 to the pulse condition determining portion 552. The pulse condition determining portion 552 sets the pulse width t, the pulse repetition frequency, and the peak power P based on the received first optical path length OL1. The pulse condition determining portion 552 can therefore set the pulse width t based on the input value of the first optical path length OL1 that reliably reflects the measurement environment. As a result, there is no concern that the pulse conditions are set based on an unintended first optical path length OL1, so that a decrease in the accuracy of the measurement performed by the laser interferometer 1 can be prevented.

Examples of the input accepting portion 570 may include a keyboard, a mouse, a touch panel, a touch pad, and a microphone.

The thus configured third embodiment can also provide the same advantages as those provided by the first embodiment described above.

### 5. Advantages Provided by Embodiments

As described above, the method for driving a laser light source according to the embodiments is a method for driving the laser light source 2 provided in the laser interferometer 1, which measures displacement of the object 14. The laser interferometer 1 includes the laser light source 2, the optical frequency modulator 12, and the photodetector 10. The laser light source 2 outputs the pulse laser light L1. The optical frequency modulator 12 modulates the optical frequency of the pulse laser light L1 to generate the reference light L2. The photodetector 10 receives the object light L3 generated when the object 14 is irradiated with the pulse laser light L1 and the reference light L2, and outputs the light reception signal. The method for driving a laser light source according to the embodiments sets the pulse width t of the pulse laser light L1 based on the first optical path length OL1 from the laser light source 2 to the object 14.

The configuration described above allows measurement of the displacement of the object 14 even when continuous oscillation laser light is not used but the pulse laser light L1 is used. The output per pulse can therefore be increased as necessary, so that the S/N ratio (signal-to-noise ratio) of the light reception signal can be increased while the period during which the laser light source 2 is driven is shortened. A decrease in the accuracy of the measurement of the object 14 can thus be suppressed while the life of the laser light source 2 is extended.

In the method for driving a laser light source according to the embodiments, it is preferable to set the pulse width t based on the difference (optical path difference ΔL) between the first optical path length OL1 and the second optical path length OL2, the latter of which is the length from the laser light source 2 to the optical frequency modulator 12.

According to the configuration described above, the pulse width t can be set more strictly.

In the method for driving a laser light source according to the embodiments, it is preferable to set the pulse width t based on the time difference (delay period Δt) between the time when the pulses of the object light L3 reach the photodetector 10 and the time when the pulses of the reference light L2 reach the photodetector 10.

The configuration described above allows the pulses of the object light L3 and the pulses of the reference light L2 to appropriately interfere with each other, so that the photodetector 10 can output the light reception signal containing an effective interference signal.

In the method for driving a laser light source according to the embodiments, it is preferable to set the pulse width t in a way that the pulse width t is longer than the time difference (delay period Δt).

The configuration described above allows the pulses of the object light L3 and the pulses of the reference light L2 to appropriately interfere with each other, so that the photodetector 10 can output the light reception signal containing an effective interference signal.

In the method for driving a laser light source according to the embodiments, it is preferable that 0.1 [ns]≤t≤100 [ns] is satisfied, where t represents the pulse width.

The configuration described above allows the photodetector 10 to receive appropriate interference light under many measurement conditions under which the laser interferometer 1 is used.

In the method for driving a laser light source according to the embodiments, it is preferable to adjust the power of the pulse laser light L1 in accordance with the pulse width t and the repetition frequency of the pulses of the pulse laser light L1.

The configuration described above allows the S/N ratio of the light reception signal to be properly increased while the laser light source 2 conforms to the safety standards.

In the method for driving a laser light source according to the embodiments, the first optical path length OL1 input by the user may be accepted, and the pulse width t may be set based on the input first optical path length OL1.

According to the configuration described above, there is no concern that the pulse conditions are set based on an unintended first optical path length OL1, so that a decrease in the accuracy of the measurement performed by the laser interferometer 1 can be prevented.

The laser interferometer according to the embodiments is a laser interferometer that measures displacement of the object 14, and includes the laser light source 2, the optical frequency modulator 12, the photodetector 10, the demodulator 52, and the light source driver 55. The laser light source 2 outputs the pulse laser light L1. The optical frequency modulator 12 modulates the optical frequency of the pulse laser light L1 to generate the reference light L2. The photodetector 10 receives the object light L3 generated when the object 14 is irradiated with the pulse laser light L1 and the reference light L2, and outputs the light reception signal. The demodulator 52 demodulates the light reception signal to extract information derived from the object 14. The light source driver 55 sets the pulse width t of the pulse laser light L1 based on the first optical path length OL1 from the laser light source 2 to the object 14, and drives the laser light source 2.

The configuration described above provides a laser interferometer 1 capable of measuring displacement of the object 14 even when continuous oscillation laser light is not used but the pulse laser light L1 is used. In the thus configured laser interferometer 1, the output per pulse can be increased as necessary, so that the S/N ratio (signal-to-noise ratio) of the light reception signal can be increased while the period during which the laser light source 2 is driven is shortened. A decrease in the accuracy of the measurement of the object 14 can thus be suppressed while the life of the laser light source 2 is extended.

In the laser interferometer according to the embodiments, it is preferable that the light source driver 55 sets the pulse width t based on the difference (optical path difference ΔL) between the first optical path length OL1 and the second optical path length OL2, the latter of which is the length from the laser light source 2 to the optical frequency modulator 12.

The configuration described above provides a laser interferometer 1 capable of setting the pulse width t more strictly.

In the laser interferometer according to the embodiments, it is preferable that the light source driver 55 sets the pulse width t based on the time difference (delay period Δt) between the time when the object light L3 reaches the photodetector 10 and the time when the reference light L2 reaches the photodetector 10.

The configuration described above provides a laser interferometer 1 capable of causing the pulses of the object light L3 and the pulses of the reference light L2 to appropriately interfere with each other and causing the photodetector 10 to output the light reception signal containing an effective interference signal.

In the laser interferometer according to the embodiments, it is preferable to set the pulse width t in a way that the pulse width t is longer than the time difference (delay period Δt).

The configuration described above provides a laser interferometer 1 capable of causing the pulses of the object light L3 and the pulses of the reference light L2 to appropriately interfere with each other and causing the photodetector 10 to output the light reception signal containing an effective interference signal.

In the laser interferometer according to the embodiments, it is preferable that the demodulator 52 performs the sampling at the sampling frequency fs, which is equal to the repetition frequency of the pulses of the pulse laser light L1.

The configuration described above allows the sampling cycle 1/fs to coincide with the cycle in which the overlap periods tr (period in which pulses of reference light L2 and pulses of object light L3 overlap with each other) appear. As a result, an effective interference signal can be reliably sampled at each of the sampling points SP.

In the laser interferometer according to the embodiments, the laser light source 2 may include the laser element 202 and the optical intensity modulator 204. The laser element 202 outputs the pulse laser light L10. The optical intensity modulator 204 modulates the intensity of the pulse laser light L10 output from the laser element 202.

The configuration described above allows the optical intensity modulator 204 to perform the optical intensity modulation in a way that the rising portion RE is, for example, removed from each of the pulses of the pulse laser light L10. The rising portion RE of each of the pulses contains wavelength fluctuation in some cases. Performing the optical intensity modulation so as to remove the rising portion RE allows removal of or reduction in the wavelength fluctuation. The laser light source 2 can thus generate pulse laser light L1 with less wavelength fluctuation.

In the laser interferometer according to the embodiments, the laser light source 2 may include a semiconductor laser element.

The configuration described above allows in particular reduction in size of the laser light source 2. Reduction in size of the laser interferometer 1 can therefore be achieved.

The method for driving a laser light source and the laser interferometer according to aspects of the present disclosure have been described above based on the embodiments shown in the drawings, but the present disclosure is not limited to the embodiments described above.

For example, the method for driving a laser light source according to the aspect of the present disclosure may have a step for any purpose added to the embodiments described above. In the laser interferometer according to the aspect of the present disclosure, the configuration of each portion in the embodiments described above may be replaced with any configuration having the same function, or any other constituent portion may be added to the embodiments described above.

The laser interferometer according to the aspect of the present disclosure can be used, for example, in a vibrometer, a tilt meter, a distance meter (length measuring device), and the like in addition to the displacement meter and the speedometer described above. In addition, examples of applications of the laser interferometer according to the aspect of the present disclosure may include: an optical comb interference measurement technology for enabling distance measurement, 3D imaging, spectroscopy, and the like; an optical fiber gyroscope that realizes an angular velocity sensor, an angular acceleration sensor, and the like; and a Fourier spectrometer including a moving mirror device.

Two or more of the laser light source, the optical frequency modulator, and the photodetector may be placed on a single substrate. The size and weight of the interference optical system are thus readily reduced, and the interference optical system is more readily assembled.

The laser interferometer according to the embodiments described above includes what is called a Michelson interference optical system, and can instead include an interference optical system of another type, for example, a Mach-Zehnder interference optical system.

What is claimed is:

1. A method for driving a laser light source provided in a laser interferometer,
the laser interferometer including
the laser light source configured to output pulse laser light,
an optical frequency modulator configured to modulate an optical frequency of the pulse laser light to generate reference light, and
a photodetector configured to receive object light generated when an object is irradiated with the pulse laser light and the reference light, and output a light reception signal,
the method comprising setting a pulse width of the pulse laser light based on a first optical path length from the laser light source to the object.

2. The method for driving a laser light source according to claim 1, wherein the pulse width is set based on a difference between the first optical path length and a second optical path length from the laser light source to the optical frequency modulator.

3. The method for driving a laser light source according to claim 1, wherein the pulse width is set based on a time difference between time when pulses of the object light reach the photodetector and time when pulses of the reference light reach the photodetector.

4. The method for driving a laser light source according to claim 3, wherein the pulse width is set in a way that the pulse width is longer than the time difference.

5. The method for driving a laser light source according to claim 1, wherein 0.1 [ns]≤t≤100 [ns] is satisfied, where t represents the pulse width.

6. The method for driving a laser light source according to claim 1, wherein power of the pulse laser light is adjusted in accordance with the pulse width and a repetition frequency of the pulses of the pulse laser light.

7. The method for driving a laser light source according to claim 1, wherein
the first optical path length input by a user is accepted, and
the pulse width is set based on the input first optical path length.

8. A laser interferometer comprising:
a laser light source configured to output pulse laser light;
an optical frequency modulator configured to modulate an optical frequency of the pulse laser light to generate reference light;
a photodetector configured to receive object light generated when an object is irradiated with the pulse laser light and the reference light, and output a light reception signal;
a demodulator configured to demodulate the light reception signal to extract information derived from the object; and
a light source driver configured to set a pulse width of the pulse laser light based on a first optical path length from the laser light source to the object, and drive the laser light source.

9. The laser interferometer according to claim 8, wherein the light source driver is configured to set the pulse width based on a difference between the first optical path length and a second optical path length from the laser light source to the optical frequency modulator.

10. The laser interferometer according to claim 8, wherein the light source driver is configured to set the pulse width based on a time difference between time when the object light reaches the photodetector and time when the reference light reaches the photodetector.

11. The laser interferometer according to claim 10, wherein the pulse width is set so that the pulse width is longer than the time difference.

12. The laser interferometer according to claim 8, wherein the demodulator is configured to perform sampling at a sampling frequency that is equal to a repetition frequency of the pulses of the pulse laser light.

13. The laser interferometer according to claim 8, wherein
the laser light source includes
a laser element configured to output the pulse laser light, and
an optical intensity modulator configured to modulate an intensity of the pulse laser light output from the laser element.

14. The laser interferometer according to claim 8, wherein the laser light source includes a semiconductor laser element.
